(19) United States
(12) Patent Application Publication
(10) Pub. No.: US 2015/0267857 A1
(43) Pub. Date: Sep. 24, 2015

(54) DUAL PURPOSE ATTACHMENT POINT SYSTEM AND METHOD

(71) Applicant: Weil-McLain, Michigan City, IN (US)

(72) Inventors: Aaron Smith, La Porte, IN (US); Neil Butt, Rolling Prairie, IN (US); James Matthew Downs, Michigan City, IN (US)

(73) Assignee: Weil-McLain, Michigan City, IN (US)

(21) Appl. No.: 14/218,310

(22) Filed: Mar. 18, 2014

(51) Int. Cl. F16M 3/00; F16M 11/42; F16M 11/02

(52) U.S. Cl. CPC F16M 3/00; F16M 11/02; F16M 11/42

(57) ABSTRACT

A support system for an appliance includes: a transporting support having a transporting attaching interface that aligns with an appliance attaching interface wherein the transporting attaching interface and the appliance attaching interface are configured to align with each other to allow the transporting support to securely attach to the appliance via the transporting attaching interface and the appliance attaching interface; a temporary support that connects to the appliance at a place different than the appliance attaching interface; and a permanent support having a permanent attaching interface having dimensions substantially the same as the transporting attaching interface such that the permanent support attaches to the appliance at the appliance attaching interface when the transporting support is not attached to the appliance. A method for both transporting and supporting the appliance may also be provided.

### FIELD OF THE INVENTION

The present invention relates generally to a system and method for moving and securing a household appliance. More particularly, the present invention relates to a system and method to move a household appliance and then secure the appliance in place with a seismic restraint.

### BACKGROUND OF THE INVENTION

Many household appliances could suffer ill effects if the appliance was moved or jostled after installation. For example, combustion devices such as furnaces, boilers, water heaters, gas dryers, or any other household (or commercial appliance) are best fixed in place during installation to prevent moving or jostling of the appliance.

For example, some areas are prone to have relatively frequent minor earthquakes. These earthquakes could move an appliance after it is installed if the appliance is not properly secured. As a result, some local building codes require seismic restraints for some types of equipment installed in buildings. Manufacturers of these types of equipment usually provide for or allow attachment points on the equipment for seismic restraints.

These appliances or combustion devices may be very heavy and it may be desirable to modify them so they can be easily moved during installation. Of course, ease of manufacture and the desire to keep the apparatus as simple as possible to reduce costs may discourage manufacturers from elaborate solutions to the above-mentioned problems.

Accordingly, it is desirable to provide a system and method that will allow an installer to install an appliance using a seismic restraint and also allow the installer to easily move the appliance in position prior to installation.

### SUMMARY OF THE INVENTION

The foregoing needs are met, to a great extent, by the present invention, wherein in one aspect, an apparatus is provided that in some embodiments will provide a system and method that will allow an installer to install an appliance using seismic restraint and also allow the installer to easily move the appliance in position prior to installation.

In accordance with one embodiment of the present invention, a support system for an appliance is provided. The system may include: a transporting support having a transporting attaching interface that aligns with an appliance attaching interface wherein the transporting attaching interface and the appliance attaching interface are configured to align with each other to allow the transporting support to securely attach to the appliance via the transporting attaching interface and the appliance attaching interface; a temporary support that connects to the appliance at a place different than the appliance attaching interface; and a permanent support having a permanent attaching interface having dimensions substantially the same as the transporting attaching interface such that the permanent support attaches to the appliance at the appliance attaching interface when the transporting support is not attached to the appliance.

In accordance with another embodiment of the present invention, a method of transporting and supporting an appliance may be provided. The method may include: moving the appliance on the transporting support to a desired location; supporting the appliance with a temporary support; removing the transporting support; installing the permanent support in the same place where the transporting support was located; and supporting the appliance with the permanent support.

In accordance with yet another embodiment of the present invention, a support system for an appliance may be provided. The support system may include: means for transporting and supporting the appliance having a first means for interfacing that aligns with a second means for interfacing located on the appliance wherein the first means for interfacing and the second means for interfacing are configured to align with each other to allow the means for transporting and supporting to securely attach to the appliance via the first and second means for interfacing; means for temporarily supporting the appliance at a place different than the second means for interfacing; and means for immovably supporting the appliance having a third means for interfacing, the third means for interfacing having dimensions substantially the same as the first means for interfacing such that the means for immovably supporting the appliance attaches to the appliance at the second means for interfacing when the means for transporting and supporting the appliance is not attached to the appliance.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a partial side view of an appliance resting on a floor via a wheel in accordance with the present disclosure.

FIG. 2 is a partial, perspective view of an appliance in accordance with the present disclosure.

FIG. 3 is a partial, bottom view of an attaching interface located on the appliance in accordance with the present disclosure.

FIG. 4 is a partial, perspective, exploded view of an appliance in accordance with the present disclosure.

FIG. 5 is a partial, perspective, view of a seismic restraint.

FIG. 6 is a partial side view of an appliance attached to the floor with the seismic restraint.

### DETAILED DESCRIPTION

An example embodiment of the invention will now be described with reference to the drawing figures, in which like reference numerals refer to like parts throughout. An embodiment in accordance with the present disclosure provides a system for attaching a wheel or set of wheels to an appliance to enable the appliance to be easily moved during installation. A temporary support is also provided on the appliance to support the appliance while the wheel is removed and replaced with a permanent support such as a seismic restraint.

In another embodiment, a method is provided to allow an appliance to be easily moved to a desired location, support the appliance while wheel(s) are removed and place a seismic restraint on the appliance at the place where the wheel was formally located.

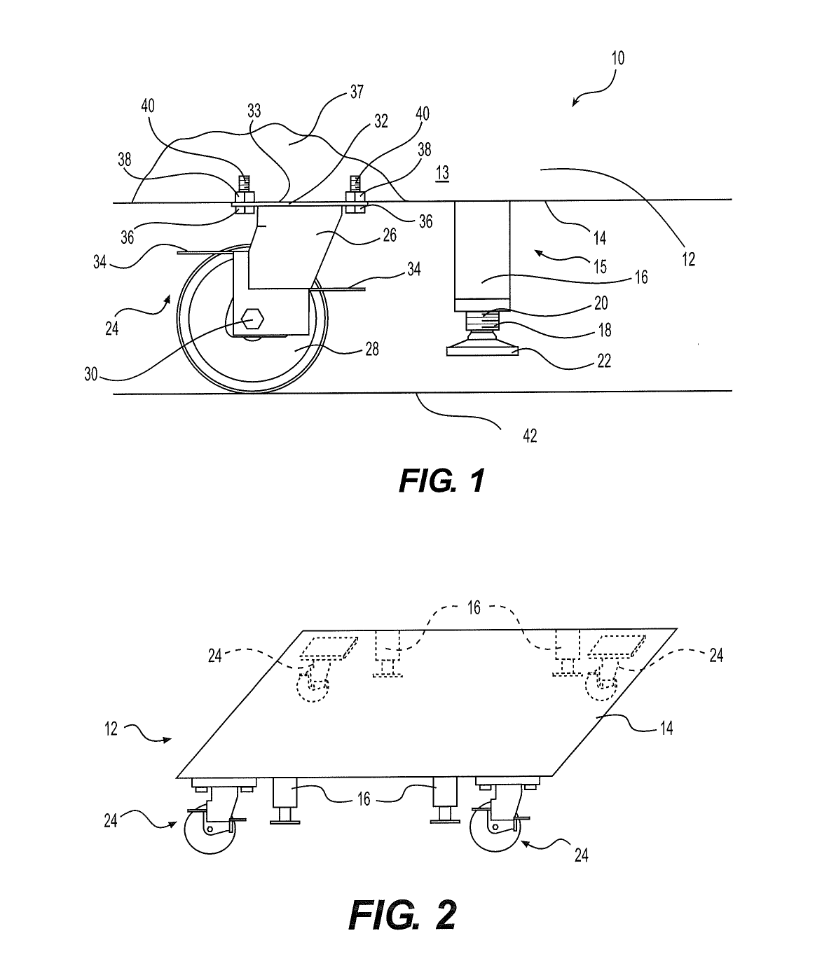

An embodiment of the present disclosure is illustrated in FIG. 1. FIG. 1 illustrates a system 10. The system 10 includes an appliance 12. The appliance 12 may be any appliance, but in certain embodiments, it is a combustion device such as, but not limited to, a boiler, a furnace, a hot water heater, or any other combustion device. The appliance 12 may have a housing 13. The appliance 12 may also have a frame 14. A support leg system 15 is attached to the frame 14. The support leg system 15 may provide a temporary supporting function which will be described further later below.

The support leg system 15 may include a support leg 16 and a support leg extension 18 which may be equipped with threads 20. In some embodiments, the support leg extension 18 can extend or retract as it is turned due to the threads 20. In the embodiment illustrated in the figures, the threads 20 are located externally to the support leg extension 18 and internally within the support leg 16. However, in some embodiments these may be reversed and the threads 20 may be externally located on the support leg 16 and internally within the extension member 18. In other embodiments, the support leg 16 and extension members are not equipped with threads, but may extend and retract using other suitable means.

In other embodiments, the support leg system 15 uses a leg 16 with no extension member 18. In some embodiments, the support leg extension 18 may be equipped with a support foot 22. The support foot 22 will contact the floor when the appliance 12 is being supported by the support leg system 15. An example of when the appliance 12 will be supported by the report leg system 15 is when other support mechanisms are being removed and are installed onto the appliance 12 as shown, for example, in FIG. 2.

Returning to FIG. 1, the appliance 12 may also, at least initially, be equipped with a wheel assembly 24. The wheel assembly 24 may provide ease in transporting the appliance 12 to a desired location. In some embodiments, an appliance 12 may be equipped with multiple wheel assemblies 24 as shown, for example, in FIG. 2.

FIG. 2 illustrates an appliance 12 equipped with four wheel assemblies 24 as well as four support leg systems 15. For the sake of clarity, only a lower portion of the frame 14 below is shown rather than the housing 13 and any other portion of the appliance 12 located above the lower portion of the frame 14. It will be understood that many appliances 12 can be easily maneuvered when they are supported by four wheel assemblies 24 as shown. While four sets of wheel assemblies 24 and four sets of support legs 16 are shown, one of ordinary skill in the art will understand that appliance 12 may have more or fewer sets of wheel assemblies 24 and support legs 16 in accordance with the present disclosure.

Returning to FIG. 1, the wheel assembly 24 may include a bracket 26 which allows a wheel 28 to attach to the bracket 26 by an axle bolt 30. The bracket 26 may also be equipped with an attaching plate 32 which allows the wheel assembly 24 to attach to an attaching interface 33 on the appliance 12. The wheel assembly 24 may, in some embodiments, include a lock plate 34 which allows a user to depress or lift up on the lock plate 34 to respectively engage or disengage a brake for the wheel 28. Such locking mechanisms are commonly known with casters and will not be described in further detail herein.

The wheel assembly 24 can be attached to the appliance 12 by attaching bolts 36. A broken away portion 37 of the housing 13 allows for illustration of the attaching bolts 36 extending through the attaching plate 32 and attaching interface 33. The attaching bolts 36 may attach the wheel assembly 24 with attaching nuts 38 located on a threaded shaft 40 as shown. While bolts and nuts are shown, in other embodiments, other suitable attachable mechanisms may also be used. In some embodiments, the attaching mechanisms will be removable for reasons that will be stated further below.

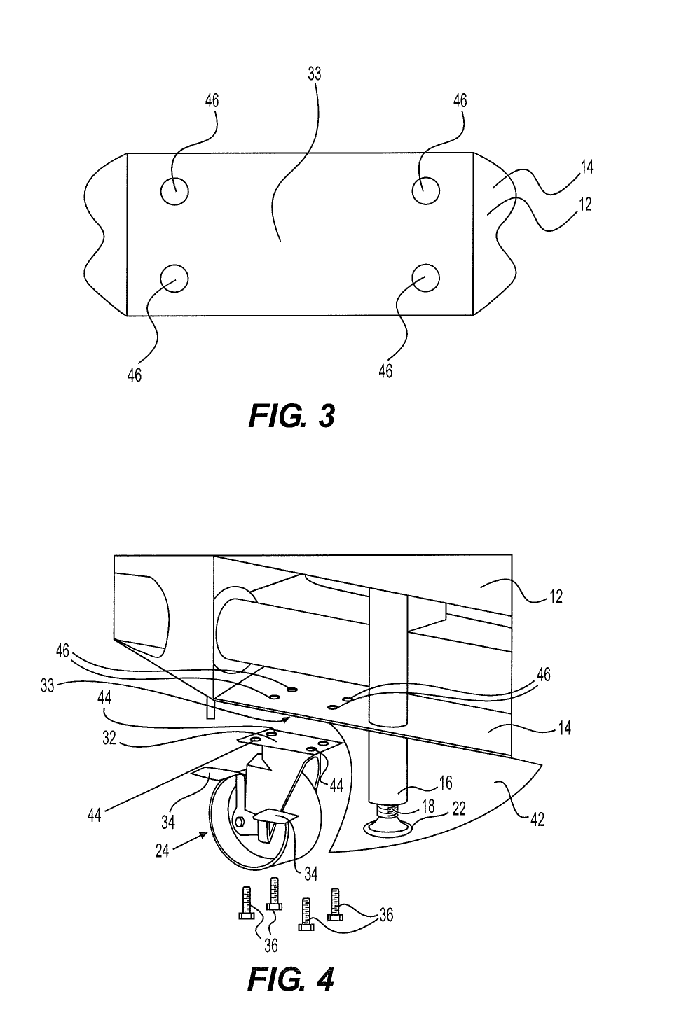

FIG. 3 illustrates a partial, bottom view of the attaching interface 33 located on the underside of the frame 14 of the appliance 12. The holes 46 in the frame 14 are shown. It is also understood that the attaching interface 33 is relatively flat. The attaching interface 33 thereby has a corresponding contour with the attaching plate 32 which acts as an interface for the wheel assembly 24. While the attaching interface 33 and the attaching plate 32 are shown to be flat, other contours may also be used if those contours correspond to permit the attaching plate 32 to securely attach the wheel assembly 24 to the attaching interface 33 on the appliance 12.

Once an appliance 12 has been moved to a desirable location, the support leg extension 18 may be extended from the support leg 16 to cause the support foot 22 to engage the floor 42 as illustrated in FIG. 4. The attaching bolts 36 may be removed to allow the wheel assembly 24 to be removed from the attaching interface 33 on the appliance 12. FIG. 4 also shows the holes 44 in the attaching plate 32 and holes 46 in the frame 14. In some embodiments, the attaching bolts 36 extend through both the holes 44 in the attaching plate 32 and holes 46 in the undersurface of the frame 14. Another view of the lock plate 34 is also seen.

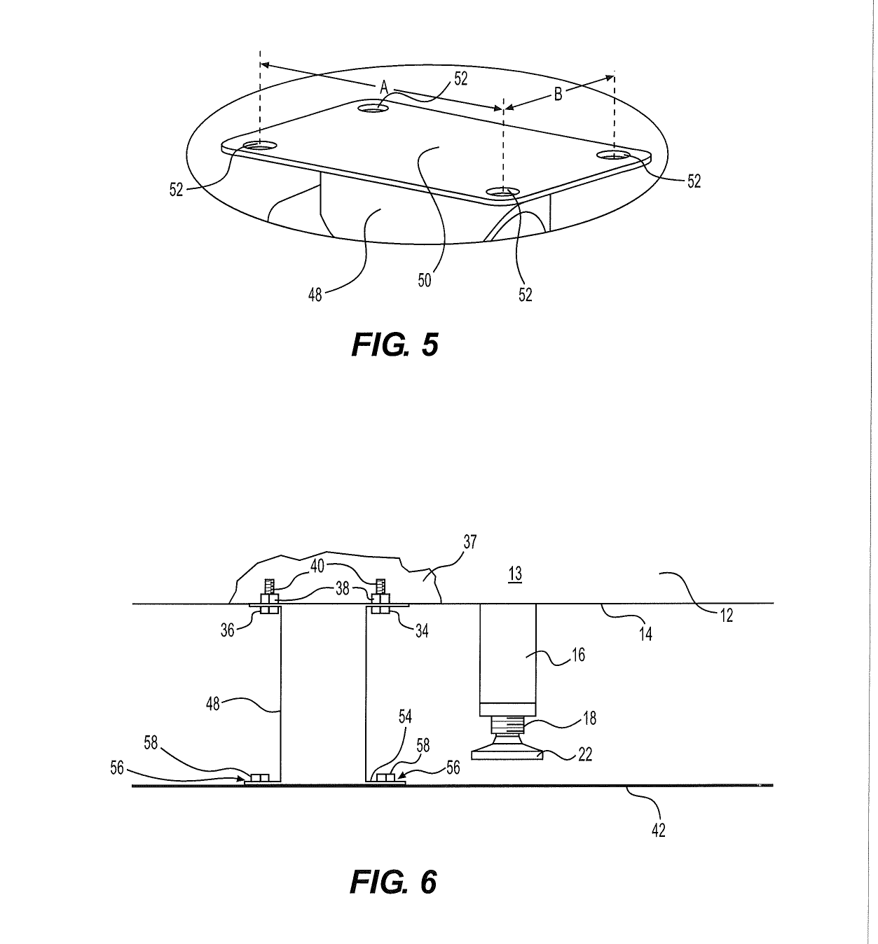

FIG. 5 is a partial perspective view of a seismic restraint 48. The seismic restraint 48 is also equipped with an interface plate 50 which is dimensioned similar to the attaching plate 32 on the wheel assembly 24 shown in FIG. 4. The interface plate 50 on the seismic restraint 48 is equipped with holes 52 which are dimensioned to align with the holes 46 in the underside of the frame 14 shown in FIG. 4. In some embodiments, the distance between the holes as illustrated by reference character A is about 2.95 inches. The dimension illustrated by reference character B is about 1.75 inches. These example dimensions are exemplary and in no way limit the scope of the claims. In other embodiments, other dimensions for holes could also be used. Further, more or fewer holes than the four illustrated may also be used in accordance with this disclosure.

FIG. 6 illustrates a partial side view of the appliance 12 where the seismic restraint 48 is installed onto the floor 42. In the embodiment shown in FIG. 6, the wheel assembly 24 has been removed. The seismic restraint 48 has been installed at the same place, at the attaching interface 33. FIG. 6 illustrates that the attaching bolts 36 are attached to attaching nuts 38 on the threaded shaft 40 of the attaching bolts 36. These attaching bolts 36 and attaching nuts 38 securely secure the seismic restraint 48 to the appliance 12. The seismic restraint 48 is also bolted to the floor 42. The seismic restraint 48 is equipped with a floor plate 54 which has holes 56 through which bolts 58 secure the seismic restraint 48 to the floor 42. While bolts are described and illustrated, one of ordinary skill in the art after reviewing this disclosure will understand the other fasting methods and systems that may be used in accordance with this disclosure.

The seismic restraint 48 acts as a permanent support for the appliance 12. The support leg extension 18 has been retreated up into the support leg 16 causing the support foot 22 to disengage from the floor 42. In other embodiments, the support foot 22 may also engage the floor 42, as well as the seismic restraint 48.

FIGS. 1, 4, and 6 illustrate a method for installing the appliance 12. First, the appliance 12 is wheeled to a desired location. The support leg extension 18 is then extended and may lift the wheel assembly 24 off of the floor 42 (not shown). Then, as shown in FIG. 4, the wheel assembly 24 may be removed. Then, the seismic restraint 48 may be installed at the attaching interface 33 that was previously occupied by the wheel assembly 24. The seismic restraint 48 is also secured to the floor 42 and then the support leg extension 18 may be moved to retreat into the support leg 16 to thereby disengage with the floor 42 as shown in FIG. 6.

In some embodiments, the feature of providing a common attaching interface 33 for both the wheel assembly 24 and the seismic restraint 48 reduces the need for duplication of parts and reduces the need for the seismic restraint 48 and the wheel assembly 24 to attach at different locations on the appliance 12 creating a large attaching footprint.

The inclusion of the support leg 16 and support leg extension 18 to provide a built-in temporary support of the appliance 12 during the removal of the wheel assembly 24 and the installation of the seismic restraint 48. In some embodiments, the appliance 12 is equipped with the wheel assembly 24, the attaching interface 33, the support leg 16, and support leg extension 18 altogether as a kit so that someone installing the appliance 12 can have all the necessary parts altogether in a convenient and easy to install package.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A support system for an appliance comprising:
a transporting support having a transporting attaching interface that aligns with an appliance attaching interface wherein the transporting attaching interface and the appliance attaching interface are configured to align with each other to allow the transporting support to securely attach to the appliance via the transporting attaching interface and the appliance attaching interface;
a temporary support that connects to the appliance at a place different than the appliance attaching interface; and
a permanent support having a permanent attaching interface having dimensions substantially the same as the transporting attaching interface such that the permanent support attaches to the appliance at the appliance attaching interface when the transporting support is not attached to the appliance.

2. The support system of claim 1, wherein the transporting attaching interface and the permanent attaching interface attach to the appliance attaching interface via removable fasteners.

3. The support system of claim 2, where the movable fasteners include nuts and bolts.

4. The support system of claim 1, wherein both the transporting attaching interface and the permanent attaching interface each include a plate having holes configured to align with holes in the appliance attaching interface.

5. The support system of claim 1, wherein the temporary support does not include fasteners.

6. The support system of claim 1, wherein the temporary support includes an extendable member.

7. The support system of claim 6, wherein the extendable member includes threads and is configured to extend and retract depending on which way the extendable member is turned on the threads.

8. The support system of claim 1, further comprising a foot located on the temporary support.

9. The support system of claim 1, wherein the permanent support is a seismic restraint.

10. The support system of claim 9, wherein the permanent support includes a second attaching interface configured to allow the permanent support to be secured to a floor.

11. The support system of claim 10, wherein the permanent support is bolted to the floor.

12. The support system of claim 1, wherein the transporting support includes a caster.

13. The support system of claim 12, wherein the caster has a brake.

14. The support system of claim 1, wherein the transporting support, the temporary support, and the permanent support, are all included as a kit with the appliance.

15. The support system of claim 1, further including a plurality of transporting supports, transporting attaching interfaces, appliance attaching interfaces, temporary supports, permanent supports and permanent attaching interfaces all associated with the same appliance.

16. A method of transporting and supporting appliance comprising:
moving the appliance on the transporting support to a desired location;
supporting the appliance with a temporary support;
removing the transporting support;
installing the permanent support in the same place where the transporting support was located; and
supporting the appliance with the permanent support.

17. The method of claim 16, wherein supporting the appliance with the temporary support includes extending an extendable member.

18. The method of claim 17, further including turning the extendable member on threads.

19. The method of claim 16, wherein removing the transporting support includes removing fasteners from holes in the appliance and installing the impermanent support that includes installing fasteners connecting the permanent support into the holes.

20. A support system for an appliance comprising:
means for transporting and supporting the appliance having a first means for interfacing that aligns with a second means for interfacing located on the appliance wherein the first means for interfacing and the second means for interfacing are configured to align with each other to allow the means for transporting and supporting to securely attach to the appliance via the first and second means for interfacing;
means for temporarily supporting the appliance at a place different than the second means for interfacing; and
means for immovably supporting the appliance having a third means for interfacing, the third means for interfacing having dimensions substantially the same as the first means for interfacing such that the means for immovably supporting the appliance attaches to the appliance at the second means for interfacing when the means for transporting and supporting the appliance is not attached to the appliance.
